(19) United States
(12) Patent Application Publication
(10) Pub. No.: US 2011/0106289 A1
(43) Pub. Date: May 5, 2011

(54) METHOD FOR MONITORING AN INDUSTRIAL PLANT

(76) Inventors: Hajrudin Efendic, Linz (AT); Gerald Hohenbichler, Kronstorf (AT); Andreas Schrempf, Waidhofen an der Ybbs (AT); Stephan M. Winkler, Walding (AT)

(21) Appl. No.: 13/002,542

(22) PCT Filed: Jul. 7, 2009
(86) PCT No.: PCT/EP09/58406

§ 371 Date: Jan. 4, 2011

(51) Int. Cl. G06F 17/00

(52) U.S. Cl. 700/110

(57) ABSTRACT

A method for monitoring plants, in particular complex plants in the iron and steel industry, having the steps of recording at least two channels of measurement data of a plant, if appropriate storing the measurement data, defining a target channel from the measurement data, preprocessing the measurement data, preparing at least one model of the target channel on the basis of the measurement data, and using the model thus generated and currently determined measurement data to detect fault conditions of the plant. This is to monitor industrial plants to improve the quality of the recorded measurement data of the plant, and reduce the volume of the measurement data, without a significant loss of information. Preprocessing the measurement data are subjected to the method steps of 1) detecting and eliminating “zero channels”, 2) detecting and eliminating outliers, 3) filtering, and 4) downsampling.

The present invention relates to a method for preprocessing measurement data for the purpose of monitoring an industrial plant.

In concrete terms, the invention relates to a method for monitoring plants, in particular complex plants in the iron and steel industry, comprising the steps of recording at least two channels of measurement data of a plant, if appropriate storing the measurement data, defining a target channel from the measurement data, preprocessing the measurement data, preparing at least one model of the target channel on the basis of the measurement data, and using the model thus generated and currently determined measurement data to detect fault conditions of the plant.

Computer-aided methods for monitoring plants and/or processes are known to the person skilled in the art from the terms Fault Diagnosis or Fault Detection (FD below, for short), see, for example, WO 02/086726 A1. These methods for detecting fault conditions in complex industrial plants include the following method steps:

a) acquiring measurement data of at least two channels of a plant,

b) storing the measurement data, if appropriate

c) defining a target channel from the acquired channel of the measurement data,

d) preprocessing the measurement data, if appropriate,

e) preparing at least one model of the target channel on the basis of the measurement data,

f) using currently determined measurement data and the model prepared in order to calculate a simulated value of the target channel, and

g) detecting fault conditions from the comparison between the current and the simulated value of the target channel.

Modern industrial plants, for example blast furnaces or rolling mills, typically having a large number of coupled individual plants, are highly complex technical systems. At present, in order to monitor these plants and/or processes a measurement data acquisition system is used to sense hundreds to thousands of measurement sensors permanently and in real time (for example with a sampling time of 1 ms), and to display particularly relevant data. However, in complex plants increasing use is being made of FD by reason of the high demands made of the operating staff, since these methods permit faults to be detected in plants with the aid of computers and, if appropriate, permit a relevant plant area to be identified. FD is, moreover, used in preprocess monitoring of industrial plants. In this case, too, a plant is monitored by means of a multiplicity of measurement sensors and a warning or fault message is generated automatically in the case of a variation in the plant behavior—resulting, for example, from wearing of components. The measurement data are typically diverse preprocess of plants and/or processes that are determined by sensors and recorded, mostly in digital form, by a measurement data acquisition system. A channel of measurement data is understood as a juxtaposition of measured values that have been recorded by a sensor; a target channel is understood as a channel of the recorded measurement data that can include or includes relevant information relating to the behavior of the plant. In the simplest form of FD, a model for the target channel is prepared that is based on one or more channels (except for a target channel) of measurement data of the plant; the values of a simulated target channel are calculated by a process computer by means of this model and as a function of current measurement data, and are compared with current measured values of the target channel; a fault message is generated in the event of significant deviations between the simulated and the measured target channel.

In the publication by H. Efendic, L. del Re and G. Frizberg. Iterative Multi-Step Diagnosis Process for Engine Systems. Presented at the SAE World Congress, Apr. 11 to 14, 2005. Detroit, Mich., USA reference is made to the importance of the preprocessing of measurement data, the English phrase being data preprocessing, in the course of FD. In concrete terms, it is proposed to filter the measurement data in order to remove disturbances in the measurement data, and thus to improve the performance of FD.

Further-reaching measures for preprocessing measurement data are not specified.

It is an object of the invention to provide a method for monitoring industrial plants with the aid of which the quality of the recorded measurement data of the plant can be improved, and the volume of the measurement data greatly reduced, without the result of a significant loss of information. Subsequently, it is possible to generate very compact models for detecting fault conditions of the plant (FD), if appropriate doing so online, that is to say by means of a process computer which is assigned to the plant and has if appropriate a low power, based on these compressed measurement data, which models are also suitable for being applied to valuable process computers with a comparatively low power, and which yet exhibit a high quality with reference to fault recognition.

This object is achieved by a method in the case of which in a step of preprocessing the measurement data are subjected to the method steps of

1) detecting and eliminating “zero channels”,

2) detecting and eliminating outliers,

3) filtering, and

4) downsampling.

Since so-called “zero channels”, that is to say channels of measurement data that are constantly 0 at all sampling instants, include no sort of information, these channels are deleted, and thus the number of channels relevant to the further steps is reduced.

When outliers are being detected and eliminated, outliers that are, for example, unjustified with reference to process management are detected in the measurement data and subsequently eliminated. The elimination of an outlier is performed by replacing an outlier with a mean value of the relevant channel.

During filtering, the measurement data channels are smoothed, for example by the application of median filters, as a result of which there is, for example, a reduction in measurement noise, and the quality of the measurement data is increased, as in the case of the detection and elimination of outliers.

During downsampling, the information content of a data channel is determined before the downsampling, and compared with the information content of a data channel that has been varied with reference to the sampling time. If the downsampling, that is to say a reduction in the sampling frequency, does not significantly change the information content, the sampling frequency is reduced, the result being the possibility of a sharp reduction in the data volume (a reduction in sampling frequency by 50% reduces the data volume likewise by 50%).

When being preprocessed the measurement data are advantageously subjected to the method steps in the sequence of detecting and eliminating “zero channels”, detecting and eliminating outliers, filtering and downsampling. This sequence results in a high quality of the measurement data and in a high efficiency of the inventive method.

In an advantageous embodiment, preferably after downsampling, the measurement data are subjected to a detection of stationary areas and elimination of nonstationary areas, the result being a further reduction in the volume of the measurement data, and the preparation of simple, static process models is enabled for subsequent FD.

A further advantageous embodiment consists in that for different target channels the steps of defining a target channel from the measurement data, preprocessing the measurement data and preparing at least one model of the target channel per target channel on the basis of the measurement data are carried out at least once in each case, and models prepared in the process are used in detecting fault conditions of the plant. As a result of this, particularly comprehensive monitoring of the plant is achieved.

In a further advantageous embodiment, for different target channels the steps of defining a target channel from the measurement data, preprocessing the measurement data and preparing at least one model of the target channel on the basis of the measurement data are carried out in parallel on at least one process computer. This means that a model can soon be made available, particularly in online operation, that is to say when carrying out the method on a process computer assigned to the plant. The parallelization can be performed either by a plurality of tasks or threads on one process computer, and/or by distribution over a plurality of process computers.

In an advantageous embodiment of the inventive method, the detection and elimination of outliers includes a univariate and a multivariate step. The univariate method step is particularly suitable for detecting and eliminating comparatively large outliers in a channel independently of other channels. By contrast, in the case of the multivariate step the spacing of the measured values of all the channels is determined in relation to the overall distribution at one instant, thus enabling even outliers that are difficult to recognize to be detected and eliminated.

In a further advantageous embodiment, the measurement data are subjected to median filtering. Median filters are known to the person skilled in the art and enable a very efficient smoothing of signals.

In a further advantageous embodiment, the downsampling of the measurement data is performed while taking account of the auto-mutual information between a channel before and after downsampling. It is hereby possible to reduce the sampling frequency as a function of the information loss by the downsampling, and thus to set an optimized downsampling rate.

A further advantageous embodiment consists in that the detection of stationary areas and elimination of nonstationary areas are carried out by taking account of statistical characteristics for the variability. Stationary areas can be detected easily and reliably by means of this measure, and this leads to a high quality of the models.

Preferably after downsampling or after the detection of stationary areas and elimination of nonstationary areas, the measured data are advantageously subjected to a detection and elimination of redundant channels. The number of relevant channels is further reduced by means of this step; in this case, it is possible to take account of complete redundancies and also, if appropriate, of redundancies that result from a depreciation or integration of a signal.

Further advantages and features of the present invention emerge from the following description of nonrestrictive exemplary embodiments, reference being made to the following figures, in which:

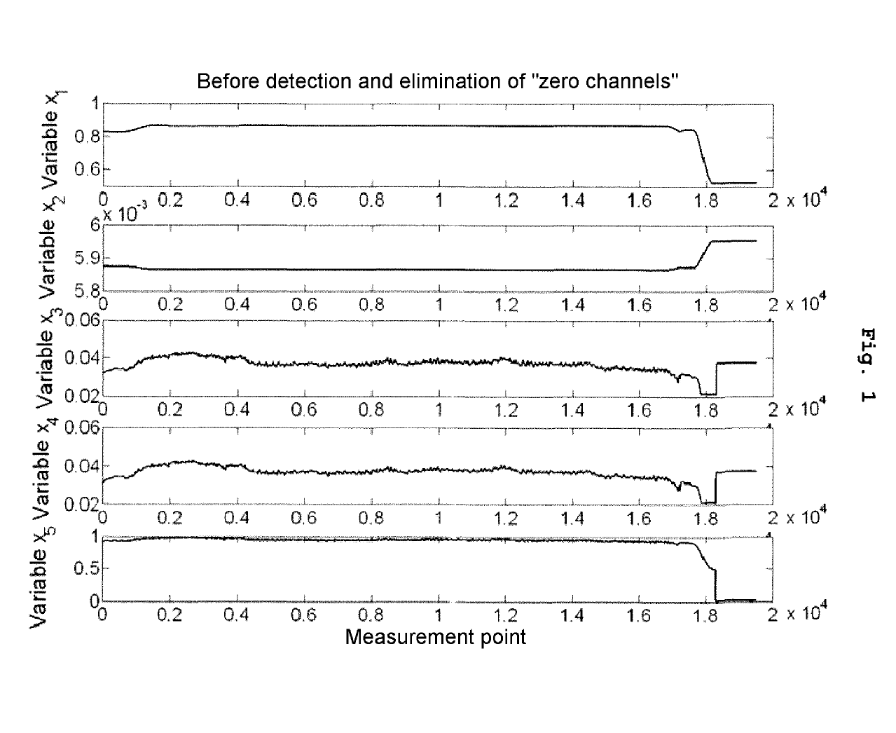

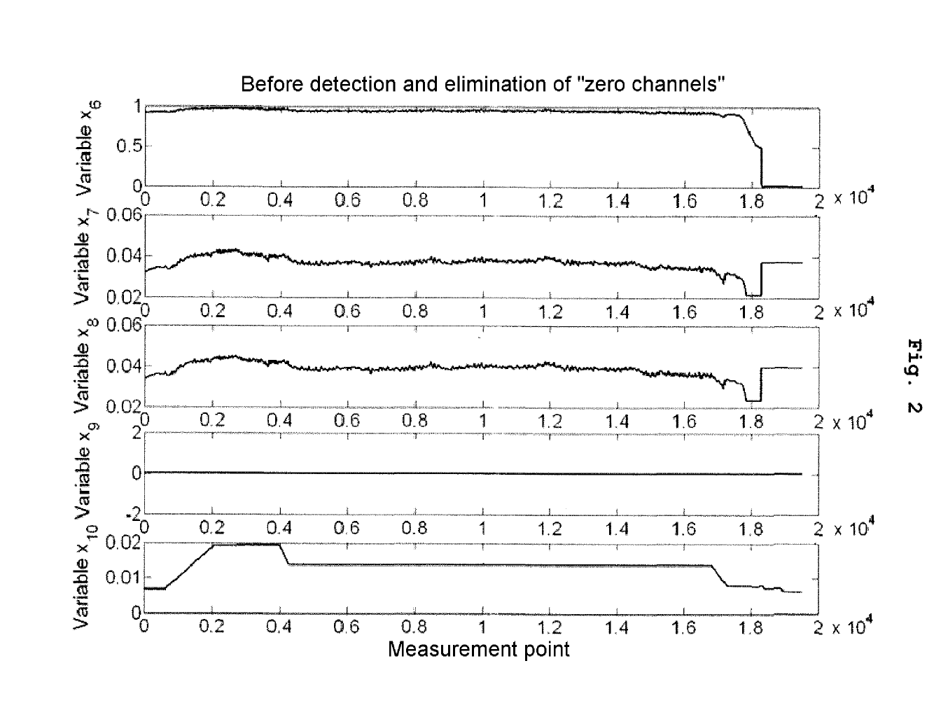

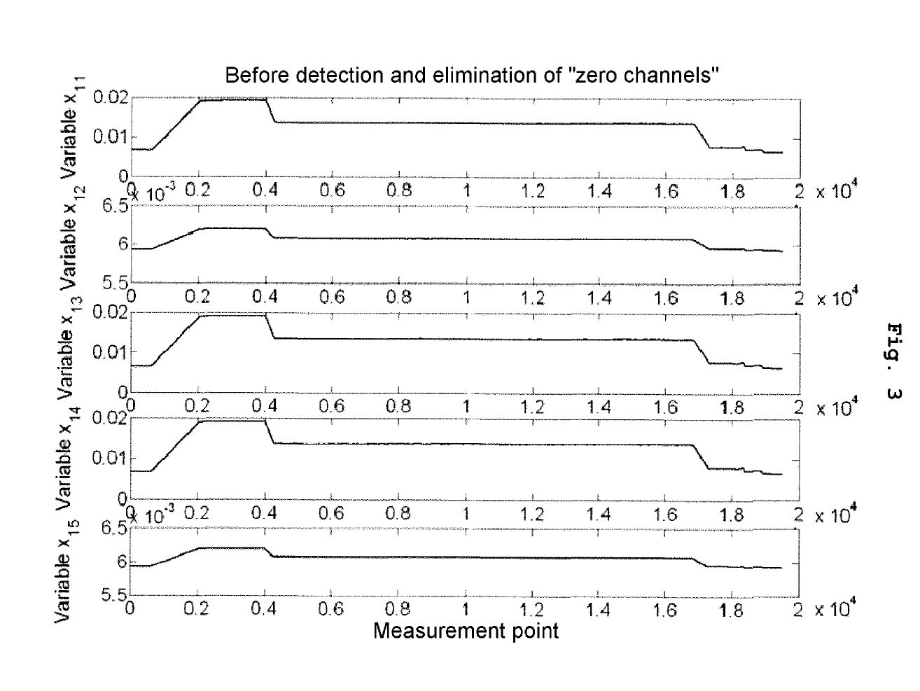

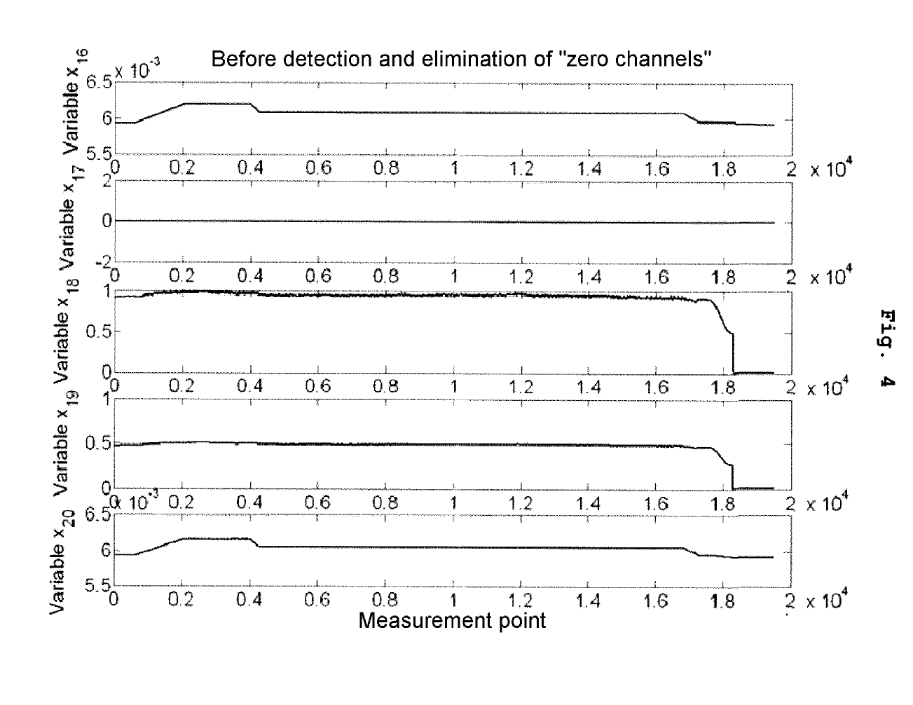

FIG. 1 to FIG. 4 show plots of the channels x₁ to x₂₀ of the unchanged measurement data of a plant,

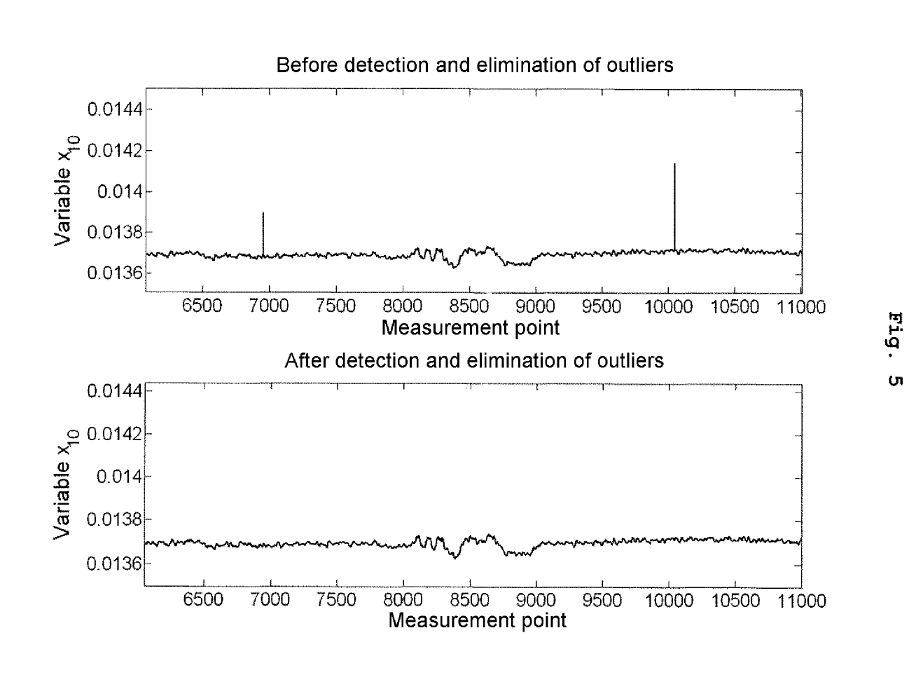

FIG. 5 shows a plot of a section of the target channel x₁₀ before and after the step of detecting and eliminating outliers,

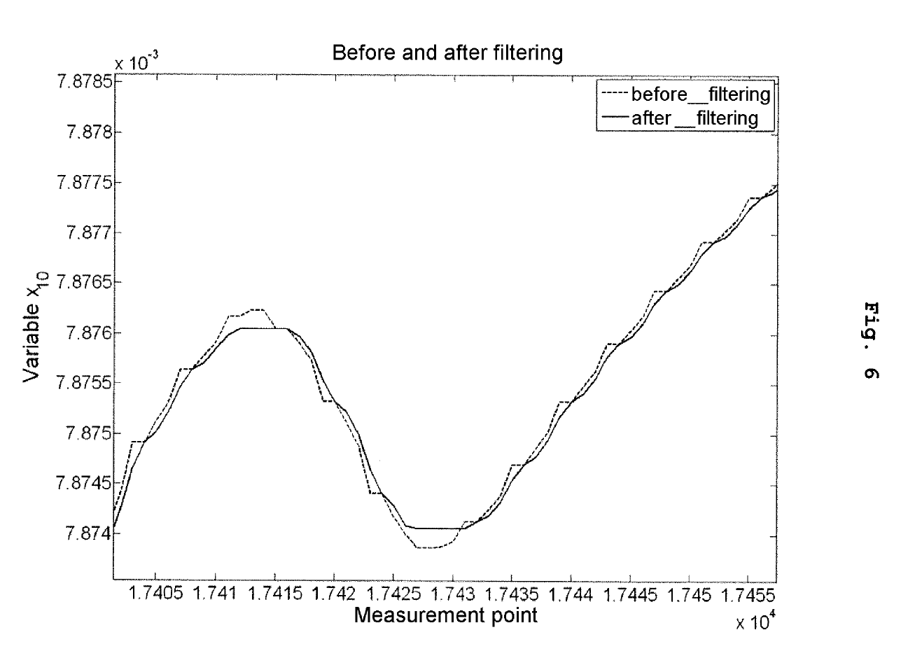

FIG. 6 shows a plot of a section of the target channel x₁₀ before and after the step of filtering,

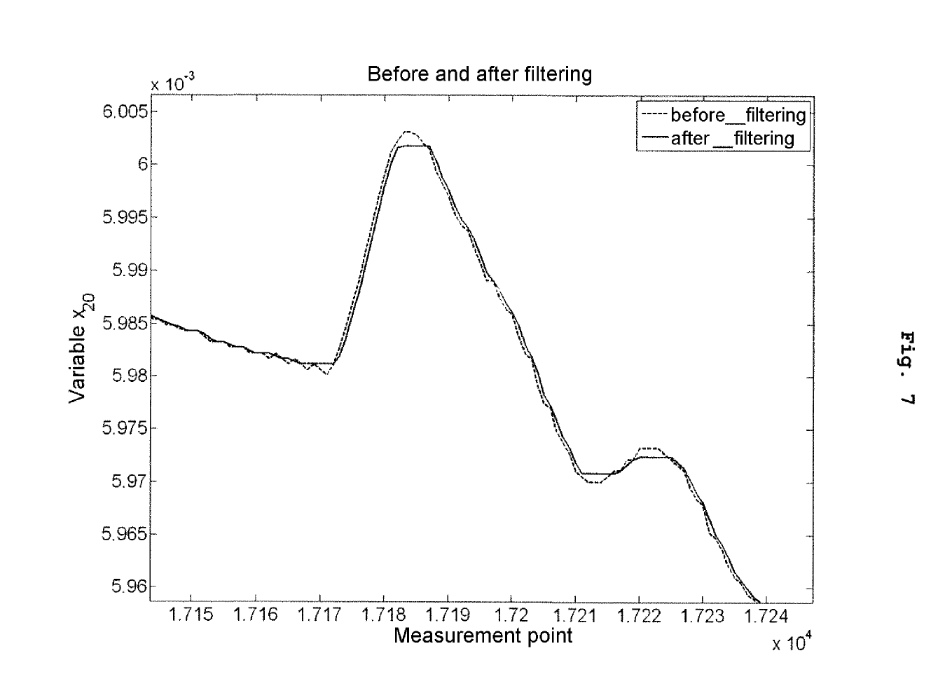

FIG. 7 shows a plot of a section of the channel x₂₀ before and after the step of filtering,

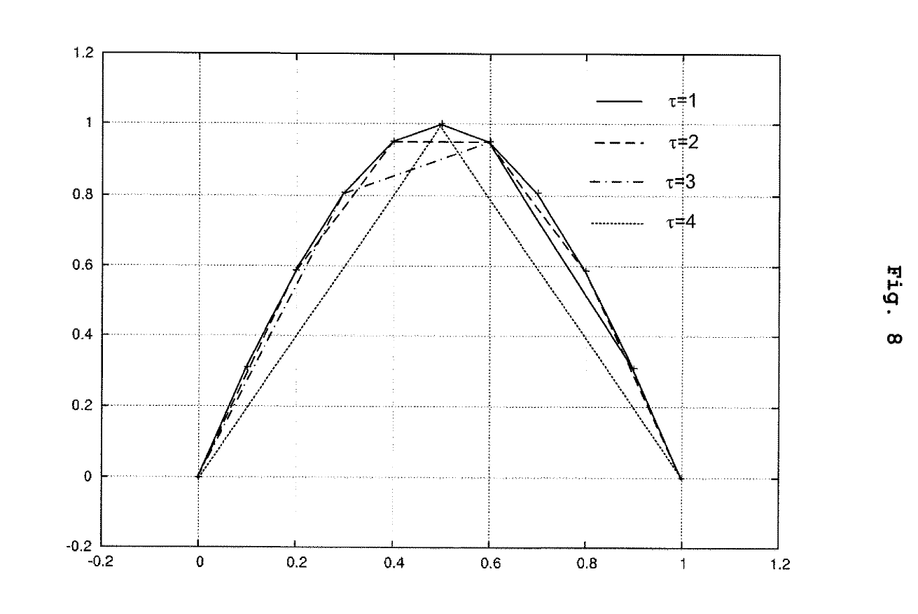

FIG. 8 shows a schematic of the downsampling,

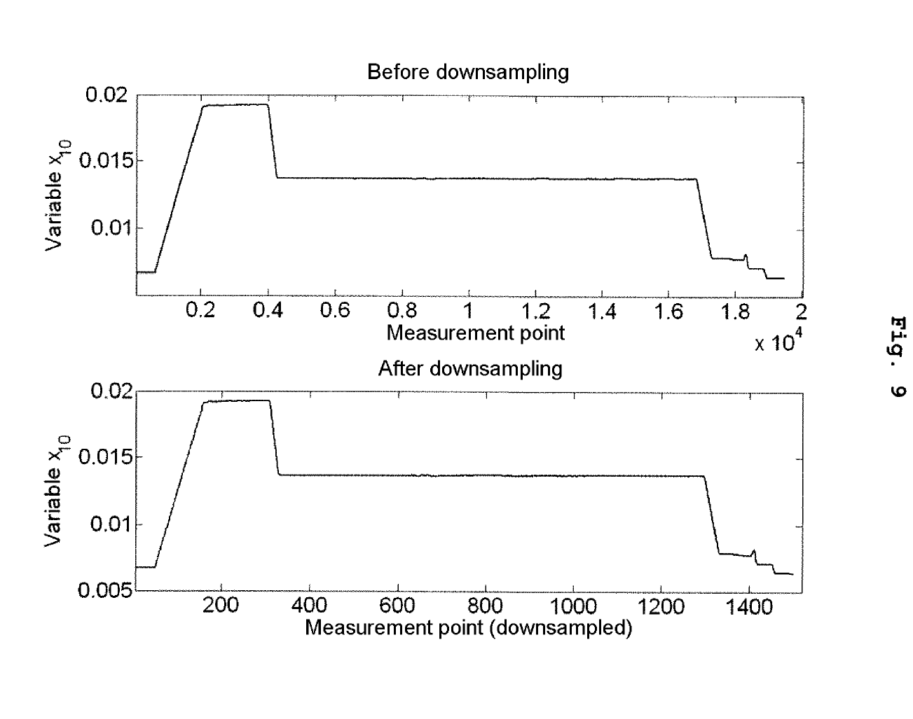

FIG. 9 shows a plot of the target channel x₁₀ before and after the step of downsampling,

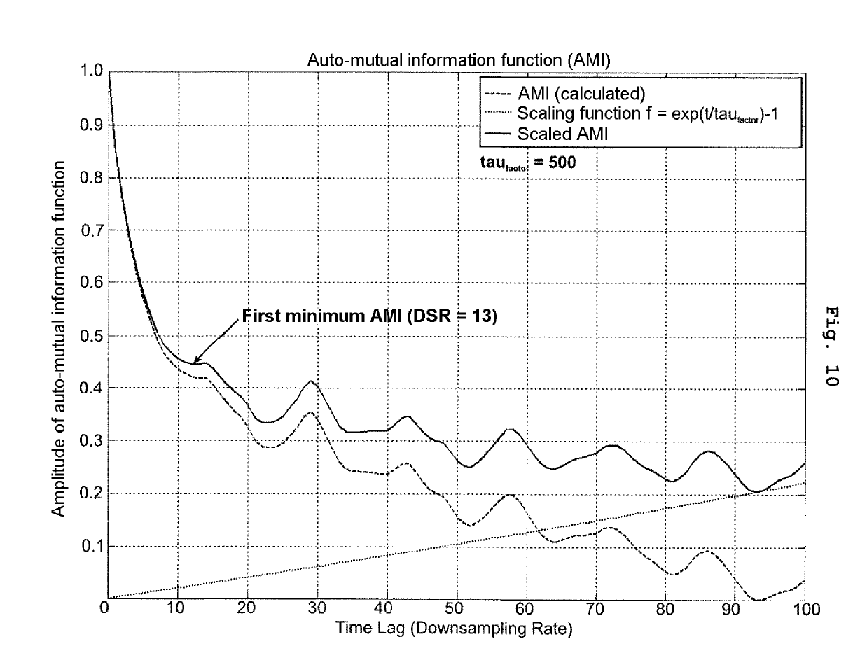

FIG. 10 shows representations of the auto-mutual information and of the scaled auto-mutual information, as a function of the downsampling rate,

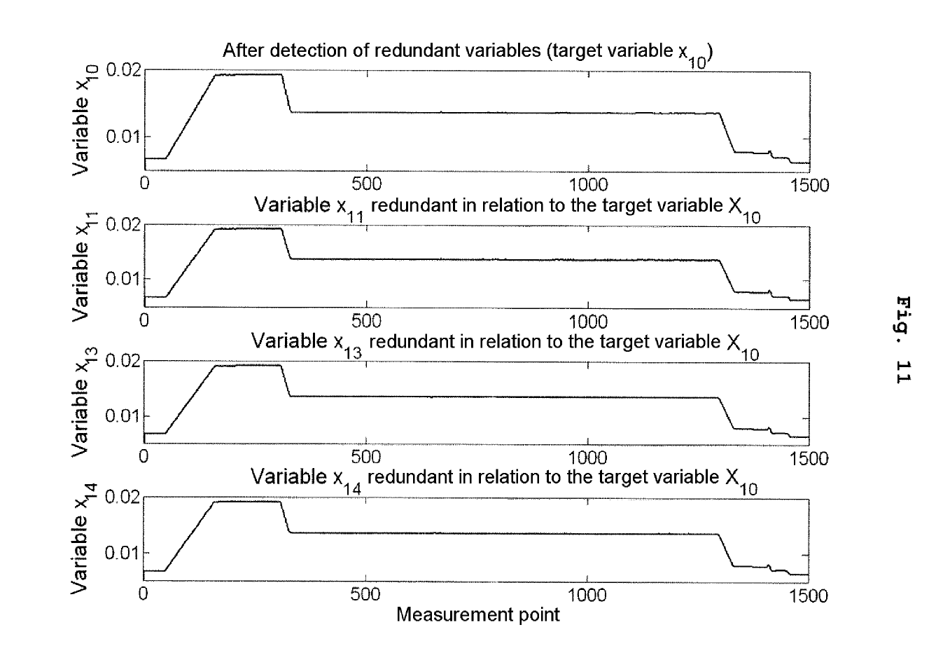

FIG. 11 shows a plot of the target channel x₁₀ and of the channels x₁₁, x₁₃ and x₁₄ redundant in relation thereto,

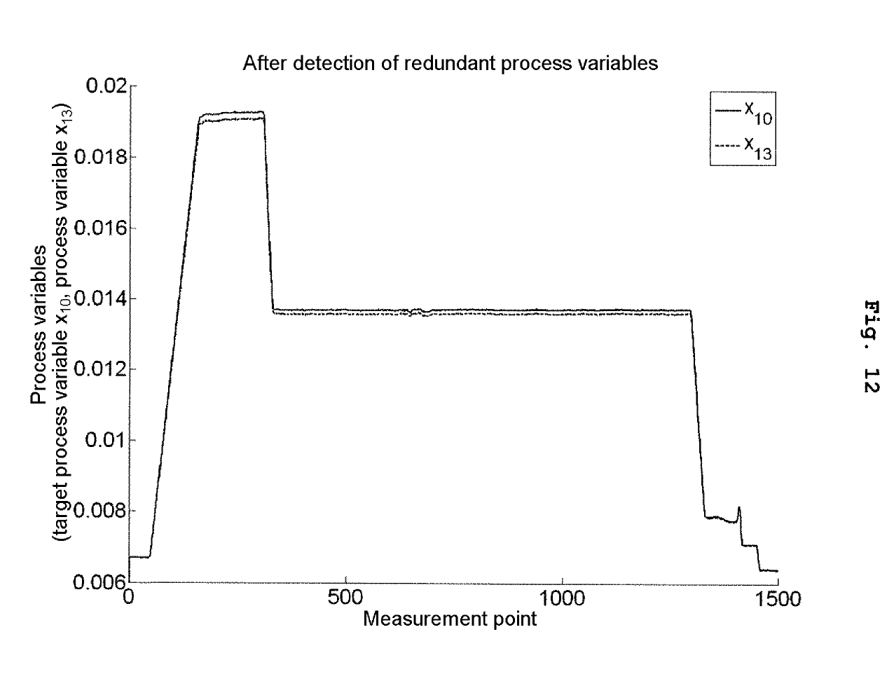

FIG. 12 shows a plot of the target channel x₁₀ and of the redundant channel x₁₃,

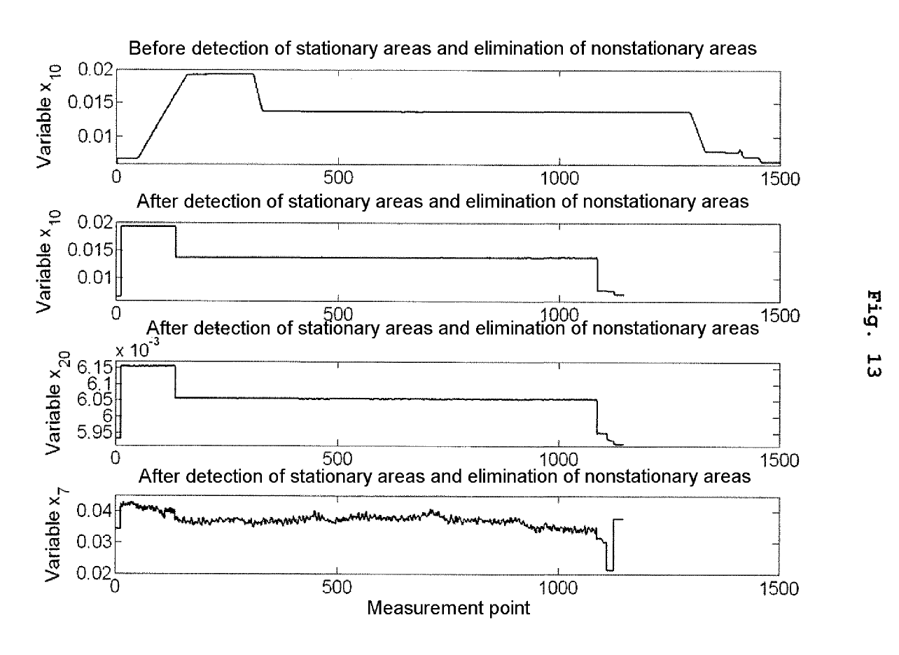

FIG. 13 shows a plot of the target channel x₁₀ before and after the step of detecting stationary areas and eliminating nonstationary areas, and the channels x₁₀, x₂₀ and x₇, and

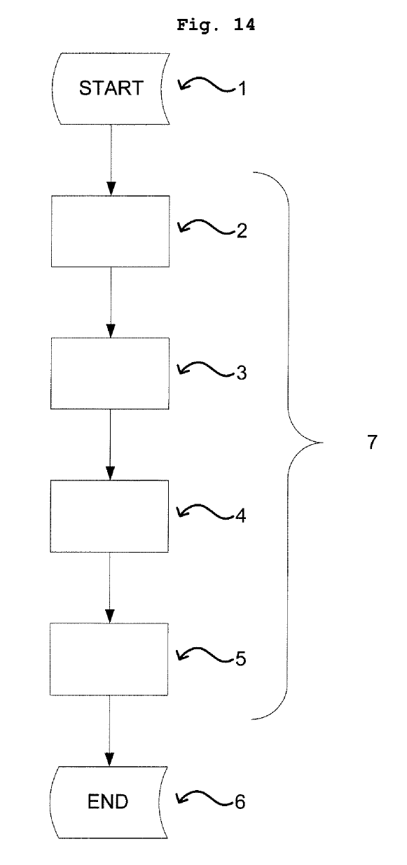

FIG. 14 is a flowchart of the most important method steps.

For reasons of clarity, the starting point below is 20 data channels (channel number n=20) and 19 498 measured values per channel (number of measured values m=19 498); the data were recorded by a measurement data acquisition system in a rolling mill (real measurement data are mostly substantially larger, for example n=400, m=1 500 000). MD symbolically exhibits a matrix of the measurement data with a dimension of 19 498×20. A measured value x_{i,j} represents the ith measured value of the jth data channel of the measurement data.

$$MD = [ \begin{matrix}{x}_{1 , 1} & {x}_{1 , 2} & … & {x}_{1 , 19} & {x}_{1 , 20} \\ {x}_{2 , 1} & {x}_{2 , 2} & … & {x}_{2 , 19} & {x}_{2 , 20} \\ ⋮ & ⋮ & ⋱ & ⋮ & ⋮ \\ {x}_{19497 , 1} & {x}_{19497 , 2} & … & {x}_{19497 , 19} & {x}_{19497 , 20} \\ {x}_{19498 , 1} & {x}_{19498 , 2} & … & {x}_{19498 , 19} & {x}_{19498 , 20}\end{matrix} ]$$

The measurement data are, for example, signals of pressure, force, displacement, speed, acceleration or temperature sensors that have been recorded for subsequent use in an FD method.

Channel x₁₀ was selected as target channel (tenth column of MD). Channels x₁ to x₂₀ are represented graphically above the measurement data index in FIGS. 1 to 4.

### 1) Detecting and Eliminating “Zero Channels”

During the detection and elimination of “zero channels”, it is those channels for which all measured values are 0 that are eliminated from the measurement data. The number of channels is thereby reduced.

A “zero channel” is present when it holds for a channel, that is to say for a column vector of MD, that

xᵢ=0 with i=1 . . . m 1)

Channels 9 and 17 have been identified as zero channels by the inventive method and eliminated. The dimension of the measurement data matrix after the step of detecting and eliminating “zero channels” is 19 498×18, that is to say the data volume has been reduced to 90%.

Subsequently, a univariate and, if appropriate, a multivariate detection and elimination of outliers is/are carried out.

### 2a) Univariate Detection and Elimination of Outliers

The first step is to subject the individual channels, that is to say the individual columns of the measurement data matrix, to a univariate (that is to say based on only one channel) detection and elimination of outliers. “Large” outliers are eliminated in this case.

The detection of outliers can be carried out in two ways:

### i) Global Detection and Elimination of Outliers

Since the carrying out of the method step on one channel of the measurement data matrix MD cannot be shown clearly, use is made of the following vector x of a channel of measurement data with m=10 elements x=[1 2 3 10 5 4 3 2 1 0]^{T}. The average and the empirical standard deviation of the vector x are

$$\begin{matrix}\overline{x} = \frac{1}{m} {\sum }_{i = 1}^{m} {x}_{i} = 3 \text{,} 1 \\ s = \frac{1}{m - 1} {\sum }_{i = 1}^{m} {( {x}_{i} - \overline{x} )}^{2} = 2.86\end{matrix}$$

The test criterion

$$G = \vert \frac{{x}_{i} - \overline{x}}{s} \vert$$

is now calculated for each measured value xᵢ. In the one-sided test, an outlier is present when

$$G > \frac{m - 1}{\sqrt{m}} \sqrt{\frac{{t}_{α / m , m - 2}^{2}}{m - 2 + {t}_{α / m , m - 2}^{2}}} ,$$

while in the two-sided test the criterion is

$$G > \frac{m - 1}{\sqrt{m}} \sqrt{\frac{{t}_{α / ( 2 m ) , m - 2}^{2}}{m - 2 + {t}_{α / ( 2 m ) , m - 2}^{2}}} .$$

By way of example, a one-sided test is subsequently applied, with α=0.05, t_{α/m,m-2}=t_{0.005,8}=3.35, the upper critical value of the t-distribution given a significance threshold of α/m and m−2 degrees of freedom (see Table IX, Appendix E1 “Tables” in H. Rinne. Taschenbuch der Statistik [Manual of Statistics], 4th edition, 2008).

An outlier is present because for the value x₄=10 the one-sided test criterion G=2.41 is larger than the limit value of 2.18; x₄ is therefore replaced by the mean value x̅=3.1. This method is now carried out for each channel until further outliers are no longer present.

### ii) Local Detection and Elimination of Outliers

It is advantageous to use a local method, given that for large data volumes a global determination and elimination of outliers is excessively expensive. The approach here is to examine a channel for outliers by means of a sliding window with NAUS elements, and to replace outliers that are found by a local average x̅_{local} inside the sliding window.

$$\begin{matrix}x = {[ … \underbrace{\begin{matrix}1 & 2 & 3 & 10 & 5 & 4 & 3 & 2 & 1 & 0\end{matrix}}_{Sliding window with NAUS element} … ]}^{T} \\ {\overline{x}}_{lokal} = 3 \text{,} 1 \\ {s}_{lokal} = 2 \text{,} 86\end{matrix}$$

The test for outliers is performed by analogy with the global method, but is restricted to the sliding window.

After the detection and elimination of outliers have been carried out, there is present in turn a measurement data matrix that is free of univariate outliers, but still has the original dimension.

FIG. 5 represents the target channel x₁₀ before, and a section of the target channel after, the local detection and elimination of univariate outliers (NAUS=10, α=0.05). The detection and elimination of outliers are applied to all channels.

### 2b) Multivariate Detection and Elimination of Outliers

This method step can be carried out subsequent to the univariate detection and elimination of outliers. The approach here is to detect any outliers on the basis of the so-called Mahalanobis distance or of the distance on the basis of the so-called principal component analysis of a measured value vector x (a row vector of the measurement data matrix) of the overall distribution.

Outliers that are found are marked and replaced by local mean values.

By way of example, the Mahalanobis distance is known, together with the principal component analysis, from Mei-Ling Shyu, Shu-Ching Chen, Kanoksri Sarinnapakorn, and LiWu Chang, “A Novel Anomaly Detection Scheme Based on Principal Component Classifier”, Proceedings of the IEEE Foundations and New Directions of Data Mining Workshop, in conjunction with the Third IEEE International Conference on Data Mining (ICDM'03), pp. 172-179, Nov. 19-22, 2003, Melbourne, Fla., USA.

The calculation of the Mahalanobis distance d is, moreover, known from Chapter D3.1 “Distance measurement” in Rinne. The square of the Mahalanobis distance (distance of a measured value vector x from the center of the distribution) is defined as

$${d}^{2} = {\sum }_{i = 1}^{p} \frac{{y}_{i}^{2}}{{λ}_{i}} = \frac{{y}_{1}^{2}}{{λ}_{1}} + \frac{{y}_{2}^{2}}{{λ}_{2}} + … + \frac{{y}_{p}^{2}}{{λ}_{p}} ,$$

where

yᵢ=eᵢ(x− x̅)^{T}

p is the rank of the covariance matrix
x is the measured value vector (row vector of the measurement data matrix)
x̅ is the mean value of all the measured values
eᵢ is the ith Eigenvector of the covariance matrix
λᵢ is the ith Eigenvalue of the covariance matrix

The indices i of the N=γ·m largest distances d² are subsequently noted, and each measured value x_{i,j} with n≧j≧1 is replaced by a local mean value

$${{x}^{⋒}}_{i , j} = \frac{{x}_{i - 1 , j} + {x}_{i + 1 , j}}{2} .$$

Here, γ is a freely selectable parameter, for example y=0.005.

Subsequently, the measurement data are subjected to a principal component analysis in which the principal components of the measurement data matrix, that is to say the Eigenvalues and Eigenvectors, are calculated either via an Eigenvalue analysis r an SVD (singular value decomposition) of the covariance matrix.

A measured value x is an outlier if

$${\sum }_{i = 1}^{q} \frac{{y}_{i}^{2}}{{λ}_{i}} \geq {χ}_{q}^{2} ( α ) ,$$

where

yᵢ=eᵢ(x− x̅)^{T} and q<p

p is the rank of the covariance matrix
x is the measured value vector (row vector of the measurement data matrix)
x̅ is the mean value of all the measured values
eᵢ is the ith Eigenvector of the covariance matrix
λᵢ is the ith Eigenvalue of the covariance matrix

λ₁>λ₂> . . . >λₚ>0

χ_{q}² is the upper critical value of the chi-squared distribution with significance value α and q degrees of freedom.

As in the case of the use of the Mahalanobis distance, outliers are replaced by local mean values.

### 3) Filtering

By way of example, during filtering of the measurement data noise or other interference signals is/are removed from individual channels of the measurement signals. As an example, use is made here of a median filter with a sliding window of size N (denoted as filter order).

In the filtering, each measured value xₖ of a channel is replaced by

$${\tilde{x}}_{k} = \{ \begin{matrix}mean value ( {x}_{k - ( N - 1 ) / 2 , … , {x}_{k + ( N - 1 ) / 2}} ) & for odd N \\ mean value ( {x}_{k - N / 2 , … , {x}_{k + N / 2}} ) & for even N\end{matrix} .$$

If, for example, a starting point is a filter of second order and a vector x=[1 2 3 3.1 5 4 3 2 1 0]^{T}, the filtered vector is then x_{filt}=[1 2 2.7 3.7 4 4 3 2 1 0]^{T}.

FIG. 6 represents a section of the target channel x₁₀, and FIG. 7 represents a section of the channel x₂₀ before and after the filtering with N=10.

### 4) Downsampling

Downsampling of the measurement data is carried out taking account of the auto-mutual information (see Chapter 3.3.1.3 “Entropy-oriented measure” in Rinne) AMI(τ) between a channel before downsampling and the same channel after downsampling. The auto-mutual information AMI(τ) is calculated from

$$\begin{matrix}H ( A ) = - {\sum }_{i = 1}^{k} p ( {a}_{i} ) \cdot {log}_{2} p ( {a}_{i} ) & Entropy of channel A before downsampling \\ H ( \tilde{A} ) = - {\sum }_{j = 1}^{l} p ( {\tilde{a}}_{j} ) \cdot {log}_{2} p ( {\tilde{a}}_{j} ) & Entropy of channel A after downsampling \\ H ( A , \tilde{A} ) = - {\sum }_{i = 1}^{k} {\sum }_{j = 1}^{l} p ( {a}_{i} , {\tilde{a}}_{j} ) \cdot {log}_{2} p ( {a}_{i} , {\tilde{a}}_{j} ) & Entropy of the common distribution \\ AMI ( τ ) = H ( A ) + H ( \tilde{A} ) - H ( A , \tilde{A} ) & Auto \text{-} mutual information between A and \tilde{A}\end{matrix}$$

FIG. 8 is a schematic of the effect of downsampling; a downsampling rate of τ=i means that only each ith value of the original signal is used.

Associated auto-mutual information AMI(τ) is calculated for each downsampling rate τ=i where iε[τₘᵢₙ,τₘₐₓ]. The optimal downsampling rate, that is to say each τ for which as little information as possible is lost in conjunction with the largest possible data reduction, is the first local minimum of AMI(τ), that is to say AMI(τ−1)>AMI(τ)<AMI(τ+1). If such a minimum cannot be found, use is made of scaled auto-mutual information

$${AMI ( τ )}^{*} = AMI ( τ ) + {e}^{\frac{τ}{{τ}_{factor}}} - 1$$

such that a local minimum can be found. The factor τ_{factor} is a scaling factor and can be selected as appropriate.

FIG. 9 represents the target channel before and after downsampling, but of course downsampling is applied to all channels. The downsampling rate used is τ=13, that is to say the data volume of the measurement data was reduced to 1/13. Also represented in FIG. 10 are the auto-mutual information AMI(τ) and the scaled auto-mutual information AMI(τ)*, plotted against τ (parameter used: τ_{factor}=500).

The measurement data matrix was reduced to 6.9% of the original data volume by downsampling.

### 5) Detection and Elimination of Redundant Channels

This method step is used to identify completely redundant channels in the measurement data and subsequently eliminate them, the number of channels thereby being reduced. Use is made for this purpose of a sliding window of size NRED which is applied in pairwise fashion to the target channel X=x₁₀ and to a further channel Y, which differs from the target channel. A redundancy signal (cross correlation between the target channel X and Y inside the sliding window) is calculated inside the sliding window, with RED(i)=corr(X_{local}, Y_{local}).

X_{local}=x_{i-NRED/2:i+NRED/2}

Y_{local}=y_{i-NRED/2:i+NRED/2}

If the redundancy signal for all indices i is RED(i)>RED_{bound}, with RED_{bound}=0.95 or 0.98, for example, then channel Y is redundant with reference to the target channel X, and channel Y can be eliminated.

Channels x₁₁, x₁₃ and x₁₄, which are redundant in relation to the target channel x₁₀, are illustrated in FIG. 11, while the target channel x₁₀ and the channel x₁₃ are represented in a plot (the parameter used being RED_{bound}=0.98, NRED=150) in FIG. 12. The redundant channels are deleted from the measurement data matrix. However, it is to be noted that in relation to a target channel a redundant channel is actually also a simple model of the target channel which can be used for fault detection. The measurement data matrix was reduced to 5.89% of the original data volume by this method step.

In the detection and elimination of redundancies that result from a differentiation or integration of a target channel, the approach is substantially as above, although a numerical differentiation or integration of channel Y is carried out before the redundancy signal RED(i) is calculated.

### 6) Detection of Stationary Areas and Elimination of Non-Stationary Areas

The aim of this method step is substantially to identify constant operating points from the measurement data. Use is made for this purpose of a sliding window of size NVAR that is applied to the target channel. This window is used to calculate a variability signal VAR(i) in relation to an index i of the target channel, where VAR(i)=|max X_{local}−min X_{local}|.

X_{local}=x_{i-NVAR/2:i+NVAR/2}

Y_{local}=y_{i-NVAR/2:i+NVAR/2}

If the variability at the position i VAR(i) is smaller than a fraction of the maximum variability, that is to say VAR(i)<VAR_{bound} with VAR_{bound}=x·maxVAR(i), this area is seen as being stationary. Of course, it is also possible to use other statistical characteristics, for example the standard deviation, for the variability.

FIG. 13 represents the target channel x₁₀ before and after the detection of stationary areas and the elimination of non-stationary areas (parameter NVAR=30, x=0.2). Channels x₂₀ and x₇ are also illustrated. As shown, channel x₂₀ has dynamics similar to the target channel, and would be an interesting candidate for a simple statistical model in the sense of preparing a model (not explained in more detail here). By contrast herewith, channel x₇ has completely different dynamics than x₁₀, and would therefore not be very suitable for preparing a model.

The measurement data matrix was reduced to 4.4% of the original data volume by means of this method step.

The resulting measurement data matrix is the basis for a subsequent preparation of at least one model for the target channel. A process computer assigned to the plant uses currently determined measurement data of the plant and of the model generated in order to calculate a simulated target channel that is used to make a comparison between the simulated and the measured target channel. A warning or a fault message is generated in the event of significant deviations between these two channels. Fault conditions of a plant can be detected with particular comprehensiveness whenever not only a model of a target channel is prepared, but for different target channels at least one model is prepared in each case for the respective target channel, and models prepared are used in this case in the FD. Further-reaching steps such as, for example, the identification or the isolation of faults can be taken, for example, from the publication by H. Efendic, A. Schrempf and L. del Re. Data based fault isolation in complex measurement systems using models on demand. Presented at the Safeprocess conference, June 2003. Washington, D.C., USA.

FIG. 14 shows a flowchart of the most important method steps in the preprocessing of the measurement data. The approach here is to use a measurement data acquisition system to record and store at least two channels of measurement data (for example, from different sensors such as pressure, temperature, speed or force sensors) of a plant in the iron or steel industry. According to the definition of a target channel from the channels of measurement data, in the preprocessing of the measurement data (7) the originally present measurement data (1) are subjected successively to the method steps of
detecting and eliminating “zero channels” (2)
detecting and eliminating outliers (3)
filtering (4) and
downsampling (5),
   thereby giving rise to a sharp reduction in the data volume of the resulting measurement data (6), that is to say the number of the channels of the measurement data and/or the number of the measured values or measurement points per channel, and this, in turn, exerts a positive influence on the following steps of the FD, specifically
preparing at least one model of the target channel on the basis of the measurement data,
and using the model thus generated and currently determined measurement data to detect fault conditions of the plant.

1. A method for monitoring manufacturing plants, comprising the steps of:
recording by at least one computing device at least two channels of measurement data of a plant;
defining a target channel from the measurement data;
preprocessing by the at least one computing device the measurement data by:
detecting and eliminating “zero channels”;
detecting and eliminating outliers,
filtering, and
downsampling;
preparing by the at least one computing device at least one model of the target channel on the basis of the measurement data; and
using the model thus generated and currently determined measurement data to detect fault conditions of the plant.

2. The method as claimed in claim 1, wherein during the preprocessing, subjecting the measurement data to the steps in the sequence of detecting and eliminating “zero channels”, detecting and eliminating outliers, filtering and downsampling.

3. The method as claimed in claim 1, further comprising, after downsampling, subjecting the measurement data are subjected to a detection of stationary areas and elimination of nonstationary areas.

4. The method as claimed in claim 1, wherein for different target channels, the steps of defining a target channel from the measurement data, preprocessing the measurement data and preparing at least one model of the target channel per target channel on the basis of the measurement data are carried out at least once in each case, and models prepared in the process are used in detecting fault conditions of the plant.

5. The method as claimed in claim 1, wherein for different target channels, the steps of defining a target channel from the measurement data, preprocessing the measurement data and preparing at least one model of the target channel on the basis of the measurement data are carried out in parallel on at least one process computer.

6. The method as claimed in claim 1, wherein the detection and elimination of outliers includes at least one of a univariate and a multivariate step.

7. The method as claimed in claim 1, further comprising performing the filtering of the measurement data is by a median filter.

8. The method as claimed in claim 1, further comprising performing the downsampling of the measurement data while taking account of auto-mutual information between a channel before and after downsampling.

9. The method as claimed in claim 1, further comprising performing the detection of stationary areas and the elimination of nonstationary areas by taking account of statistical characteristics for variability.

10. The method as claimed in claim 1, further comprising after downsampling or after the detection of stationary areas and elimination of nonstationary areas, subjecting the measured data to a detection and elimination of redundant channels.

11. The method as claimed in claim 1, further comprising storing the recorded measurement data.

12. The method as claimed in claim 1, wherein the plant is a complex plant in the iron and steel industry.

13. A system for monitoring manufacturing plants, the system comprising:
at least one computing device programmed and configured to record at least two channels of measurement data of a plant;
means for defining a target channel from the measurement data;
wherein the at least one computing device is further programmed and configured to:
preprocess the measurement data by:
detecting and eliminating “zero channels”;
detecting and eliminating outliers,
filtering, and
downsampling;
prepare at least one model of the target channel on the basis of the measurement data; and
use the model thus generated and currently determined measurement data to detect fault conditions of the plant.
